(19) United States
(12) Patent Application Publication
(10) Pub. No.: US 2008/0022224 A1
(43) Pub. Date: Jan. 24, 2008

(54) PUSHED AND PULLED INFORMATION DISPLAY ON A COMPUTING DEVICE

(75) Inventor: Daryl David Coutts, Edmonton (CA)

Correspondence Address: BEYER WEAVER LLP, P.O. BOX 70250, OAKLAND, CA, 94612-0250, US

(73) Assignee: MARENGO INTELLECTUAL PROPERTY LTD., Edmonton, AB (CA)

(21) Appl. No.: 11/836,293

(22) Filed: Aug. 9, 2007

Related U.S. Application Data
(63) Continuation-in-part of application No. 11/472,132, filed on Jun. 20, 2006.
(60) Provisional application No. 60/779,654, filed on Mar. 7, 2006.
(60) Provisional application No. 60/796,185, filed on May 1, 2006.
(60) Provisional application No. 60/801,395, filed on May 19, 2006.
(60) Provisional application No. 60/809,831, filed on Jun. 1, 2006.
(60) Provisional application No. 60/814,537, filed on Jun. 19, 2006.
(60) Provisional application No. 60/843,393, filed on Sep. 11, 2006.
(60) Provisional application No. 60/842,667, filed on Sep. 7, 2006.

(51) Int. Cl. G06F 3/048

(52) U.S. Cl. 715/783

(57) ABSTRACT

Methods and systems for displaying headlines corresponding to both pushed information and pulled information are described.

### CROSS REFERENCE TO RELATED APPLICATIONS

This application is a continuation-in-part of pending U.S. application Ser. No. 11/472,132, filed on Jun. 20, 2006, which claims the benefit of priority under 35 USC §119(e) to U.S. Provisional Application No. 60/779,654, filed on Mar. 7, 2006; U.S. Provisional Application No. 60/796,185, filed on May 1, 2006; U.S. Provisional Application No. 60/801,395, filed on May 19, 2006; U.S. Provisional Application No. 60/809,831, filed on Jun. 1, 2006; and U.S. Provisional Application No. 60/814,537, filed on Jun. 19, 2006; this application also claims the benefit of priority under 35 USC § 119(e) to U.S. Provisional Application No. 60/843,393, filed on Sep. 11, 2006, and U.S. Provisional Application No. 60/842,667, filed on Sep. 7, 2006.

All of the above applications are incorporated herein by reference in their entirety for all purposes.

### TECHNICAL FIELD

This invention pertains to computerized methods and systems for displaying information on a user's computing device.

### BACKGROUND OF THE INVENTION

Today, a computer user's display is a very busy environment. The typical user has many applications running on their computer. Email, word processing, spreadsheet, instant messaging, calendar, stock portfolio, newsreader, location and even process control. As a user is trying to complete a task, they are focused on one particular application, but the other applications continue to work in the background. These background applications can send notifications to the user's screen at any moment. A user often has to attend to this notification, simply to determine the notification contents. This takes the user away from the task they are focused on. This is very intrusive. An example is when a user is working on a document in a word processor. They receive an instant message notification that is usually a flashing rectangle at the bottom of their screen and an accompanying audio herald. To determine the contents of the instant message, the user must click on the flashing rectangle at the bottom of the screen, which then expands to an instant messaging conversation window. The user then must minimize the conversation window and return to the word processor application. The instant message notification has notably disrupted the user's work in the word processor application.

Nawaz in U.S. Pat. No. 6,421,694, teaches the display of notifications in a ticker display pane similar to that illustrated in FIG. 1a. Ticker panes repeat notifications periodically to increase the chance that a user will see the notification, but unless the user is looking at the ticker pane when a particular notification goes by, they will miss it. Another drawback with ticker panes is that because they repeat notifications periodically, old notifications are sometimes displayed next to new notifications. This lack of time order, in notification display, makes review of historic notifications difficult. Further, Nawaz method only displays retrieved or pulled information—it does not handle pushed information.

Email and newsreader programs typically use notification balloons in the corner of the computer display screen. These notifications are transitory. If a user is not looking at the corner of the screen at the moment of the notification's arrival, the user will miss the notification. If a user is away from their computer while at lunch, they will miss all the notification balloons. Users do not trust that they have seen all their required notification balloons so they resort to manually checking all their applications for fresh notifications. The user checks their email application for the email they are expecting, they check their phone program to see who has called, they check their portfolio program for value of their portfolio, they check their newsgroup program to see if someone has responded to their question. All of this checking takes a lot of effort. To go through this checking cycle a user must click on the email icon to switch to their email inbox, examine their inbox, then click on the phone icon to switch to their phone inbox, examine their phone inbox, then click on the portfolio icon to switch to their portfolio application, examine their portfolio, then click on the newsgroup icon to switch to their newsgroup inbox and so on.

What is needed is a system and method such that a computer user can monitor a large number of notifications in one place. The display of notifications should be minimally disruptive to the user's current task. The computer user needs be able to act on notifications quickly, easily transitioning to the application associated with the notification. The notifications should persist so the computer user can review them at their convenience. The display of the historic notifications should facilitate rapid review by the user.

### BRIEF SUMMARY OF THE INVENTION

A method of the invention comprises integrating headlines corresponding to information pushed to a computing device with headlines corresponding to information pulled to the computing device into a sequence of headlines and displaying the sequence of headlines on a display associated with the computing device. Still further the invention comprises responding to a user indication directed at a particular headline in the displayed sequence of headlines, by launching an application or sending a message from a first application to a second application.

By integrating both pushed and pulled information into the same sequence of headlines, screen real estate on the display of a computing device is conserved. A computer user is then able to monitor a large number of disparate information sources while they focus their work in a particular application.

The displaying of the sequence of headlines is such that headlines corresponding to more recently received information at the computing device are displayed below headlines corresponding to less recently received information, in the plane of the display. The displaying of the sequence of headlines can also be such that headlines corresponding to more recently received information at the computing device are displayed above headlines corresponding to less recently received information, in the plane of the display. Also, the displayed sequence of headlines can be made user scrollable. These features facilitate rapid review of notifications by the computer user. If a user has been away from their computer for a lunch, upon their return, they can easily scroll the displayed sequence of headlines to review information received during their absence.

Headlines are added to the sequence of headlines when new information is received and the displayed sequence of headlines is then updated, this is an improvement over the prior art event viewer in FIG. 1B that only updates its display in response to user input.

The displayed sequence of headlines can be made to go partially transparent after a period of time without receiving new information or without user interaction. This also reduces effective screen real estate.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1a shows a prior art ticker pane.

FIG. 1b illustrates a prior art event log.

FIG. 2 illustrates an exemplary computing device receiving information from push and pull information sources.

FIG. 3a shows an example headline, and also a timestamp and icon with the headline

FIG. 3b illustrates a window in a user interface displaying a sequence of headlines.

FIG. 4 shows a sequence of headlines displayed on a computer screen.

FIG. 5 illustrates an example of what happens when a user clicks on a particular headline.

FIG. 6 shows flowcharts of some methods of the invention.

FIG. 7 shows a flowchart of another method of the invention.

FIG. 8 shows a window with a first sequence of headlines dedicated to pulled information and a second sequence of headlines dedicated to pushed information.

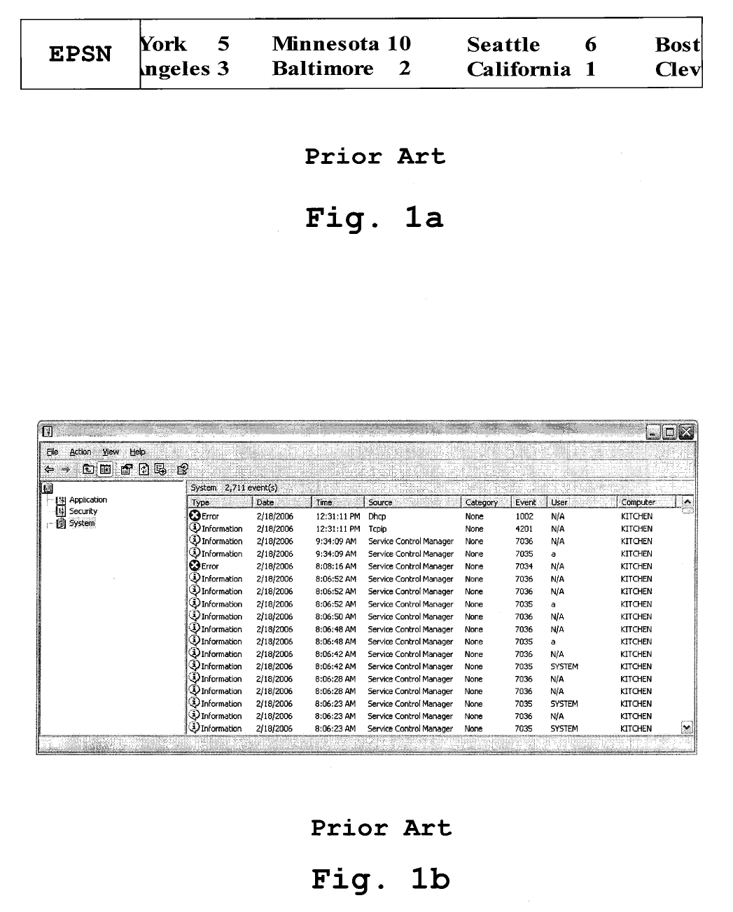

### DETAILED DESCRIPTION OF THE INVENTION

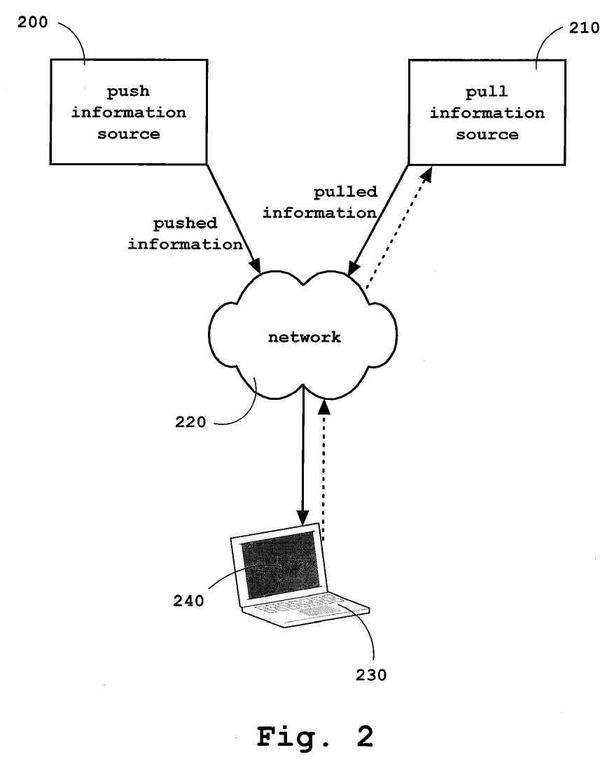

FIG. 2 shows a computing device 230 coupled via a network 220 to a push information source 200 and a pull information source 210. Only one information source of each type is shown, but there could of course be more than one information source of each type. The computing device 230 can be any suitable computing device examples of which include: cellphone, handheld, PDA, desktop computer, notebook computer. Other kinds of computing devices are within the scope of the invention. The computing device 230 has a display 240. The network 220 is any type of network, examples of networks include: internet, cellular network, home network, ether network. Other kinds of networks are within the scope of the invention.

Pulled information is information received at the computing device 230 in response to a particular request for information sent from the computing device 230. The dotted arrow in FIG. 2 represents the request for information. An example of pulled information would be the information received at a computing device 230 in response to a request for a webpage from a webpage server. A pull information source 210 has the characteristic that it sends information to a computing device 230 in response to a request for information from the computing device 230. An example of a pull information source would be a webpage server or a POP3 email server. Other examples of pull information sources are of course possible and are within the scope of the invention.

Pushed information is information received at the computing device 230 that is not pulled information. An example of pushed information could be an instant message received at a computing device 230. A push information source 200 has the characteristic that it will send information, without prompting, to a computing device 230. A typical example of a push information source 200 is an instant messaging server when it sends information to a client device. (Instant messaging servers can also be pull information sources 210 if the instant messaging protocol is implemented using HTTP but this is not a typical mode.) Other examples of push information sources are of course possible and are within the scope of the invention.

Note in FIG. 2 that the information sources 200 and 210 are external to the computing device 230.

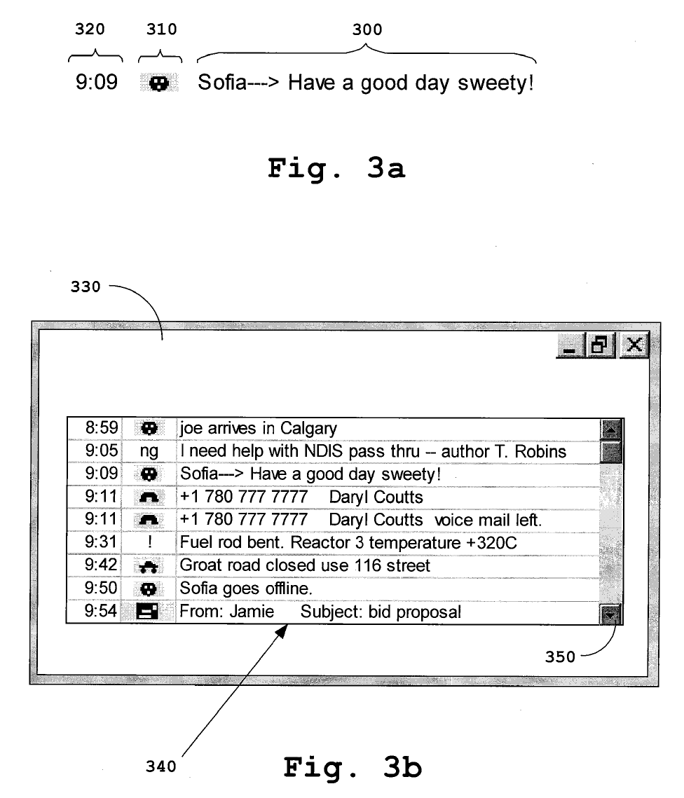

FIG. 3a shows an example headline 300 along with an icon 310 and a time stamp 320. A headline comprises characters and a headline also comprises at least one word. When a headline is displayed it can cover several rows. The icon 310 and the timestamp 320 are optional and need not be displayed when the headline 300 is displayed. An icon 310 or a time stamp 320 or other display items can be displayed along with a headline 300.

FIG. 3b illustrates a sequence of headlines 340 displayed in a window 330 of a user interface. A sequence of headlines 340 can also be displayed as part of a desktop on the display 240 of the computing device 230. The sequence of headlines 340 can also be displayed as part of a sidebar on the display 240 of the computing device 230. Some of the headlines 300 in the sequence of headlines 340 correspond to pushed information received by the computing device 230 and some of the headlines 300 in the sequence of headlines 340 correspond to pulled information received by the computing device 230. Non-text items, such as icons, can be displayed within the same area as the sequence of headlines 340.

If the sequence of headlines 340 is displayed using a user interface component that displays a subset of a list, each headline 300 can be added as an item to the list. Also, the time stamps 320 and icons 310 can be part of items added to the list. Example user interface components that could be used to display the sequence of headlines 340 include: List, ListBox, ListView, ComboBox, RichTextBox,TextBox, TextArea, TextPane, and TextEditorPane.

If the sequence of headlines 340 is displayed using a user interface component that displays a subset of a data grid or a subset of a data table, each headline 300 can be an entry in the table. Similarly, the time stamps 320 and icons 310 can be entries in the table. Example user interface components that could also be used to display the sequence of headlines 340 include: DataGrid and DataGridView.

Other ways to display the sequence of headlines 340 are possible. The sequence of headlines 340 can be displayed in a tile of a sidebar. The sequence of headlines 340 can be displayed in a panel of a sidebar. The sequence of headlines 340 can be displayed by a mini-application like a widget or a gadget.

FIG. 3b shows examples of the kinds of headlines 300 that might be in the sequence of headlines 340. FIG. 3b shows the headline 300 “joe arrives in Calgary” corresponding to information pushed to the device 230. It was added to the sequence of headlines 340 at 8:59. The push information source 200 in this case was a location server. At 9:05, the headline 340 “I need help with NDIS pass thru—author T. Robins” corresponding to information pulled to the device 230, was added to the sequence of headlines 340. The pull information source 210 in this case was a newsgroup server. At 9:09, the headline 300 “Sofia→Have a good day sweety!” corresponding to information pushed to the device 230, was added to the sequence of headlines 340. In this case, the headline 300 corresponds to pushed information from an instant messaging server—a push information source 200. Other examples of headlines 300 are shown in FIG. 3b. At 9:54 the headline “From: Jamie Subject: bid proposal” is added to the sequence of headlines 340. In this case the headline 300 corresponds to information pulled to the device 230 from a POP3 email server—a pull information source 210.

In FIG. 3b, headlines 300 corresponding to more recently received information are displayed in the sequence of headlines 340 below (in the plane of the display 240) headlines 300 corresponding to less recently received information. Alternatively, headlines 300 corresponding to more recently received information can be displayed in the sequence of headlines 340 above (in the plane of the display 240) headlines 300 corresponding to less recently received information

FIG. 3 is an example—items can be added or removed from the window 330 without departing from the invention. The timestamps, icons and scrollbars are optional. Also, there does not need to be gridlines separating the headlines 300 in the displayed sequence of headlines 340. Also of course the displayed sequence of headlines 340 could be a different size than that shown and the number of headlines 300 in the displayed sequence of headlines 340 could be different.

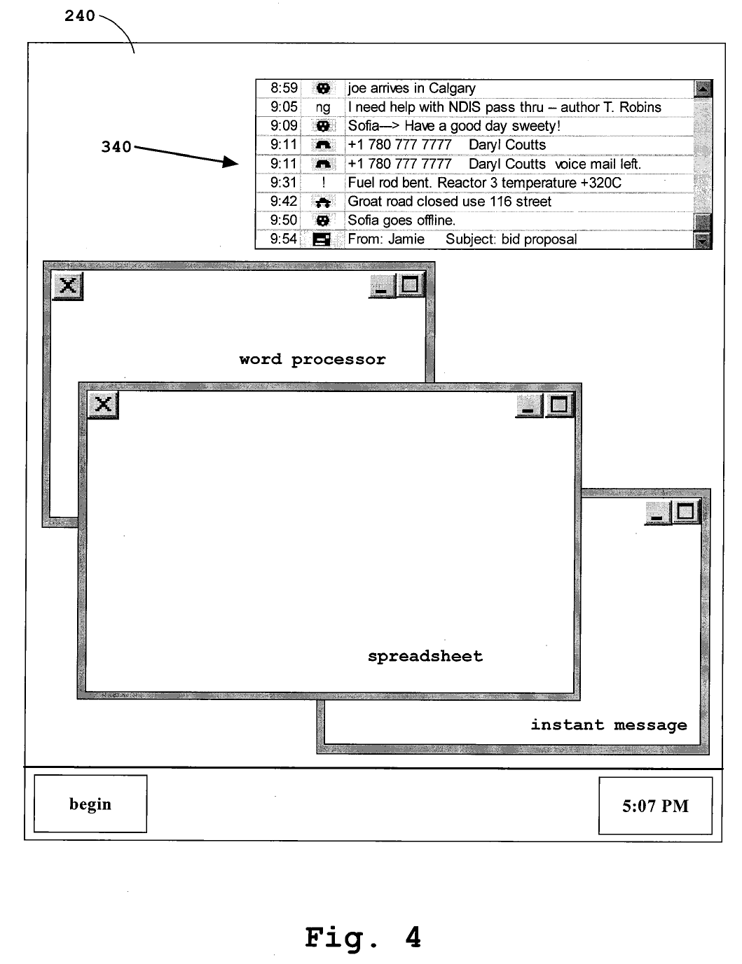

The displayed sequence of headlines 340 could completely cover the window 330 as shown in FIG. 4. FIG. 4 shows an exemplary sequence of headlines 340 as it might appear on the display 240 of a computing device 230. By having the displayed sequence of headlines 340 completely cover the window 330, the screen footprint is reduced. The functionality of minimizing, maximizing, closing and other graphical user interface functionality can be presented to the user as a pop-up menu that the user can initiate with a right-click action over the displayed sequence of headlines 340. In an alternative embodiment, the displayed sequence of headlines 340 could be part of a defined region on a desktop provided by the operating system of the computing device 230 rather than being contained in a window 330. FIG. 4 illustrates how a user can monitor the sequence of headlines 340 while still working in other applications such as word processing or spreadsheets.

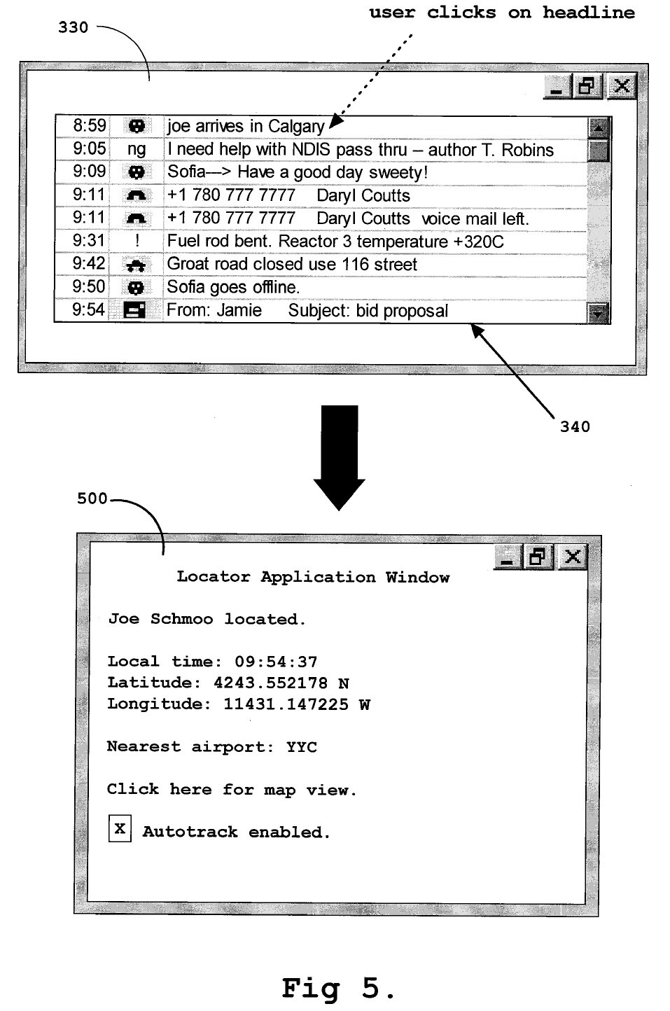

FIG. 5 illustrates what happens when a user clicks on a headline 300 in sequence of healines 340 displayed in the window 330. After the user clicks on a headline 300, a computer program is launched, or a message is sent from a first computer program to a second computer program. A message can be sent from a first computer program to a second computer program using IP (internet protocol). A message can also be sent from a first computer program to a second computer program by having the first computer program cause a function or procedure of the second computer program to be invoked. There are many other ways for a first computer program to send a message to a second computer program.

For the purpose of this document, the action of launching an application, or sending a message from a first computer program to a second computer program is termed accessing a resource.

In the example of FIG. 5, the user has clicked on the “joe arrives in Calgary” headline 300. This causes a message to be sent to a location application running on the computing device 230.

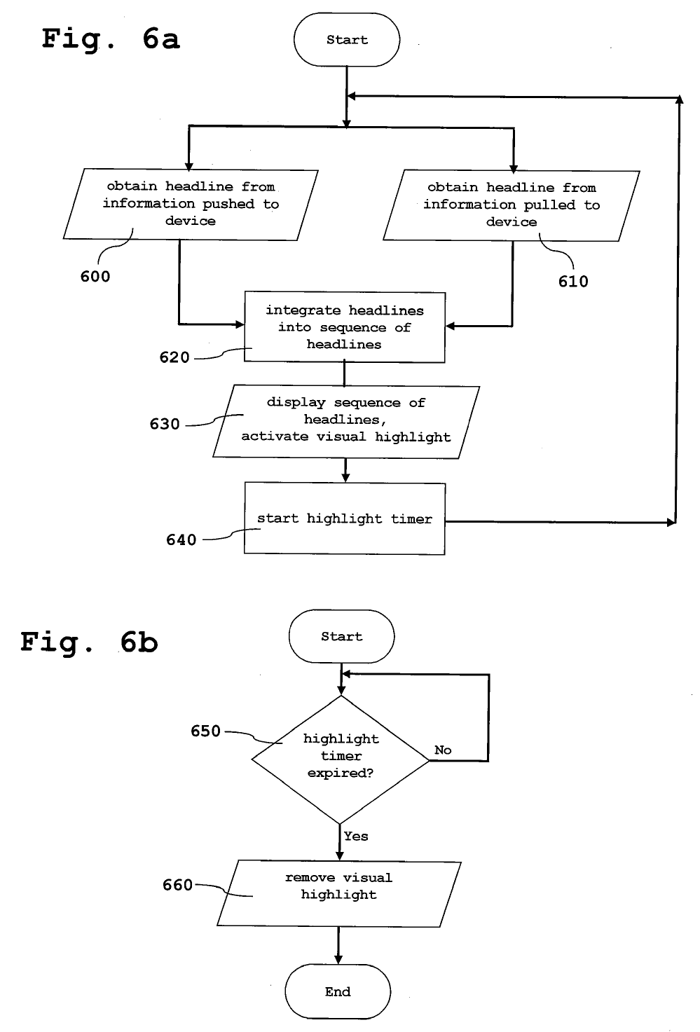

FIG. 6a shows a flowchart of a method of the invention. In step 600, a headline 300 corresponding to information pushed to the device 230 is obtained. In step 610, a headline 300 corresponding to information pulled to the device 230 is obtained. In step 620, the headlines 300 obtained in step 600 and step 610 are integrated into a sequence of headlines 340. In step 630, the sequence of headlines 340 is displayed. Optionally, in step 630, a visual highlight can be displayed proximate to the headlines 300 corresponding to the most recently received information. An example of one of many possible visible highlights is to display a headline 300 in reverse video—this draws attention to the newly displayed headline 300. Other visual highlights or no highlights can be used in step 630. In step 640, a highlight timer can be started if a visual highlight is used.

FIG. 6b is a flowchart of another method of the invention. In step 650, a timer is monitored and when the timer expires, the visual highlight is turned off—step 660.

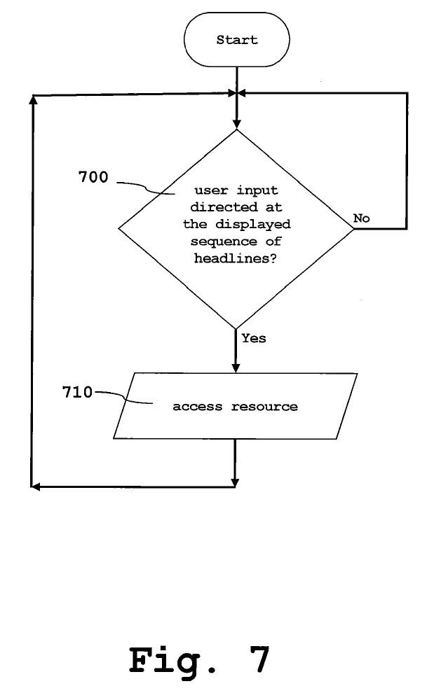

FIG. 7 is a flowchart of another method of the invention. In step 700, the displayed sequence of headlines 340 is monitored for user input. When user input is detected, step 710 is executed whereby a resource is accessed. Typically, the user input will be a single click of a mouse but other user inputs fit with the invention. Example other user inputs include a double click of a mouse, tap with a stylus and tap with a finger. Step 710 can comprise the additional step of displaying an interim user interface element that requires another indication from a user before the resource is accessed.

In FIG. 6 and FIG. 7, not all steps are required for the invention. Also, other steps could be added without departing from the invention.

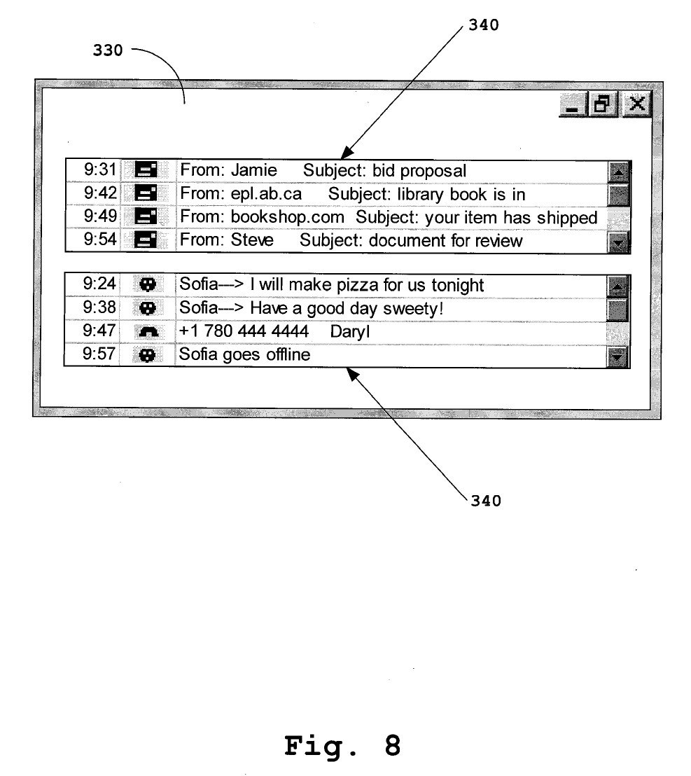

FIG. 8 shows an example of a window 330 that has two sequences of headlines 340 displayed, where one sequence of headlines 340 is dedicated to pulled information and one sequence of headlines 340 is dedicated to pushed information. The upper sequence of headlines 340 is displaying headlines 300 which correspond to emails received at the computing device 230—pulled information. The lower sequence of headlines 340 is displaying headlines 300 corresponding to instant messages and phone calls received at the computing device 230—pushed information. A sidebar on a display 240 associated with a computing device 230 could have one sequence of headlines 340 dedicated to pushed information and one sequence of headlines 340 dedicated to pulled information. Finally, a defined region on a desktop provided by the operating system of the computing device 230 could have one sequence of headlines 340 dedicated to pushed information and one sequence of headlines 340 dedicated to pulled information.

While various embodiments have been described above, it should be understood that they have been presented by way of example only, and not limitation. For example, any of the elements associated with Pushed and Pulled Information Display on a Computing Device may employ any of the desired functionality set forth hereinabove. Thus, the breadth and scope of a preferred embodiment should not be limited by any of the above-described exemplary embodiments.

What is claimed is:

1. A method of handling notifications to a user of a computing device, comprising:
integrating a first headline and a second headline into a sequence of headlines, where the first headline corresponds to information received at the computing device in a pushed manner and where the second headline corresponds to information received at the computing device in a pulled manner;
displaying the sequence of headlines on a display associated with the computing device such that headlines corresponding to information more recently received at the computing device, are displayed one of above and below headlines corresponding to information less recently received at the computing device, in the plane of the display;
receiving one or more indications of user interaction with the displayed sequence of headlines and causing a resource associated with one of the first headline and the second headline to be accessed based on an indication of user interaction with the displayed sequence of headlines being received.

2. The method of claim 1 wherein:
The information pushed to the computing device includes at least one of information relative to an instant message, a phone call, and an alarm indication.

3. The method of claim 1 wherein:
The information pulled to the computing device includes at least one of information relative to an email, to a web page, and to a newsgroup posting.

4. The method of claim 1 wherein:
When a headline is first displayed as part of the sequence of headlines, it is displayed in reverse video for a period of time and is displayed in non-reverse video thereafter.

5. The method of claim 1 wherein:
The displayed sequence of headlines becomes at least partially transparent upon occurrence of a specified condition.

6. The method of claim 5, wherein:
The specified condition includes passage of a specified period of time with no new headlines being integrated into the sequence of headlines and with no indications of user interaction being received.

7. The method of claim 1, wherein:
The user interaction is one of a single click of a mouse and a single tap of a stylus.

8. The method of claim 1 wherein:
The step of accessing a resource associated with one of the first headline and the second headline comprises displaying an additional user interface element and receiving an indication of user interaction with the additional user interface element.

9. The method of claim 1 wherein:
The step of accessing a resource further comprises sending a message from a first computer program to a second computer program where the first computer program and the second computer program are executing on the computing device.

10. The method of claim 1, where the sequence of headlines is displayed using a user interface component selected from the list of: ListBox, ListView, ComboBox, RichTextBox, TextBox, DataGridView, DataGrid, ScrollPane, SplitPane, TabbedPane, TextArea, TextPane and EditorPane.

11. The method of claim 1, where the sequence of headlines is displayed by one of a widget and a gadget.

12. The method of claim 1, where the sequence of headlines is displayed within a tile or panel.

13. A method of handling notifications to a user of a computing device, comprising:
providing a defined region on a display associated with the computing device;
integrating a first headline into a first sequence of headlines, the first headline corresponding to information received at the computing device in a pushed manner;
integrating a second headline into a second sequence of headlines, the second headline corresponding to information received at the computing device in a pulled manner;
displaying the first sequence of headlines within the defined region on the display such that headlines corresponding to information more recently received at the computing device, are displayed one of above and below headlines corresponding to information less recently received at the computing device, in the plane of the display;
displaying the second sequence of headlines within the defined region on the display such that headlines corresponding to information more recently received at the computing device, are displayed one of above and below headlines corresponding to information less recently received at the computing device, in the plane of the display;
receiving one or more indications of user interaction with the displayed first sequence of headlines and causing a resource associated with the first headline to be accessed based on an indication of user interaction with the displayed first sequence of headlines being received; and
receiving one or more indications of user interaction with the displayed second sequence of headlines and causing a resource associated with the second headline to be accessed based on an indication of user interaction with the displayed second sequence of headlines being received.

14. The method of claim 13, wherein:
The defined region is one of a sidebar and a window.

15. The method of claim 14, wherein:
The step of causing a resource associated with one of the first headline and second headline to be accessed further comprises displaying a user interface element and receiving an indication of user interaction with the user interface element.

16. The method of claim 15, where the first sequence of headlines is displayed using one of a widget and a gadget.

17. The method of claim 15, where the displayed first sequence of headlines is integrated within a tile or panel.

18. The method of claim 15, where the displayed second sequence of headlines is integrated within a tile or panel.

19. The method of claim 15, where the second sequence of headlines is displayed using one of a widget and a gadget.
